(19) United States
(12) Patent Application Publication
(10) Pub. No.: US 2008/0164233 A1
(43) Pub. Date: Jul. 10, 2008

(54) Roller boom rest

(75) Inventors: Matthew Wendell Schroeder, Ventura, IA (US); James Aaron Flatebo, Gamer, IA (US); Timothy Joseph Davison, Mason City, IA (US)

Correspondence Address: G. BRIAN PINGEL, BROWN, WINICK, GRAVES,;GROSS, BASKERVILLE AND SCHOENEBAUM, P.L.C., REGENCY WEST 5, 4500 WESTOWN PARKWAY, SUITE 277, WEST DES MOINES, IA, 50266, US

(73) Assignee: Stellar Industries, Inc.

(21) Appl. No.: 11/651,789

(22) Filed: Jan. 10, 2007

(51) Int. Cl. B66C 23/00; F16M 13/00

(52) U.S. Cl. 212/347; 248/430

(57) ABSTRACT

A new boom rest has a cylindrical roller with a V-shaped groove cut into it such that the boom rests at least partially in the groove. The roller is rotatable and made of a self-lubricating resilient non-metallic material. The rotation and the V-shape allow the boom to self-locate onto the roller. The material of the roller and self-locating prevent damage and wear on the roller and the boom. The roller is rotatably mounted on a support structure that is attachable to vehicles that carry booms.

### BACKGROUND OF THE INVENTION

1. Field of the Invention

The present invention relates to structures upon which heavy mechanical devices are secured during transport, and, more specifically, to a boom rest for the boom associated with a mechanical device mounted on a truck or other movable structure.

2. Description of Related Art

Apparatuses have long been in existence for lifting loads such as cranes. These apparatuses include various adaptations for loading and unloading items such as industrial containers, cars and other heavy objects. These apparatuses are often needed in a variety of locations including construction sites, sites for repair, and any number of delivery destinations. To meet this need, the apparatuses such as cranes have been mounted on movable platforms including truck beds and trailers.

The majority of these apparatuses include a boom either of a given length or adjustable in length. During transport, the boom needs to be secured so that it neither swings outward from the vehicle nor is bounced with the topography of the ground over which it travels. In order to secure the boom, a structure is associated with the moveable platform upon which the boom either rests or is otherwise secured. Due to the extremely heavy nature of these booms, these rests must be of heavy construction and have traditionally been of steel or other hard metal. This construction is heavy, often requires welds which create structural weak spots, and typically are not adjustable for height or boom dimension. In addition, as the boom is lowered into the rest, it must be done very accurately in order to have appropriate placement in the rest. As it is lowered, the boom often slides along the rest which causes wear to the rest and to the boom.

What was needed was a boom rest assembly of lighter construction wherein no welds are required to affix the rest to the structural support. Further, because there are a number of different sizes of booms in various sectors of the market, a boom rest assembly wherein the rests can accommodate different boom dimensions and the structural support is designed to allow for height adjustments was needed. Further, a boom rest that reduced the wear and tear caused when the boom was lowered and eased in accurate placement would also be advantageous. These advantages would provide economies of scale in manufacturing and use.

The present invention provides a boom rest assembly having the following objectives:

The first objective is to provide a boom rest assembly or equal or greater strength but less actual weight that can be produced at reduced cost;

The second objective is to provide a boom rest assembly wherein booms of various dimensions can be accommodated by a single rest or the rest can be changed out easily to accommodate a particular boom;

The third objective is to provide a boom rest wherein the wear caused when a boom slides into the rest would be reduced;

The fourth objective is to provide an assembly wherein the height of the assembly can be adjusted; and

The fourth objective is to provide a boom rest which increases the ease with which a boom can be lowered and accurately positioned in the rest.

### SUMMARY

The present invention is a boom rest assembly that has a structural support associated with a movable platform, a bracket, and a boom rest. The boom rest is associated with the structural support via the bracket.

The boom rest of the present invention is unique because it has a rotatably mounted roller with a generally V-shaped groove. The V-shape is designed to accommodate a boom having an angle or angles on its surface substantially equal to that of the V-shape. This means the boom rest of the present invention can support booms of many different sizes and increase the surface contact for hexagonal or round booms. The roller is essentially a cylinder with the V-shaped groove cut circumferentially. A pin through a boor in the cylinder is attached to a support structure with the roller preferably sitting between two flanges. As the boom is lowered, it self-locates as it slides into the V-shaped groove and rotates the roller.

The roller of the preferred embodiment of the present invention is made of a self-lubricating resilient non-metal material having sufficient strength and elasticity to withstand the weight and downward pressure of the boom as it is lowered on the rest. The preferably material diminishes wear otherwise noted on the boom and the rest and also creates a rest that is more durable and longer lasting than previous boom rests made of metal. Using plastic as such a material allows the roller to be easily molded to reflect the specific size and shape of a boom. By rotatably mounting the roller with a threaded pin and a nut, the roller is easily exchanged for rollers of different sizes and strengths for use with a wide variety of booms.

The roller of the preferred embodiment is supported by an upper portion slidably mounted on a lower portion. The lower portion is further attached to a base. The slidable relationship between the upper and lower portion allows for adjusting the height of the boom rest to correspond with varying boom heights. The base preferably includes apertures for securing the boom rest, such as on a vehicle or trailer.

Although the V-shape allows different shapes and sizes, the construction of the assembly wherein the boom rest is attached via the bracket also allows for different sizes of boom rests to cover the largest and the smallest possible boom dimensions without changing out the entire assembly. This is advantageous since most assemblies are permanently affixed to a vehicle or a trailer; here, the use of the bracket to which the boom rest is removable attached negates the need to wholly remove an assembly to accommodate a different sized boom.

### BRIEF DESCRIPTION OF THE DRAWINGS

FIG. 1 is a side view in elevation of the preferred embodiment of the present invention showing a portion of the boom and a portion of the support structure;

FIG. 2 is a perspective view of the roller of the preferred embodiment;

FIG. 3 is a perspective view in of the preferred embodiment of the present invention; and

FIG. 4 is an exploded view of the preferred embodiment shown in FIG. 3.

### DESCRIPTION OF THE PREFERRED EMBODIMENT(S)

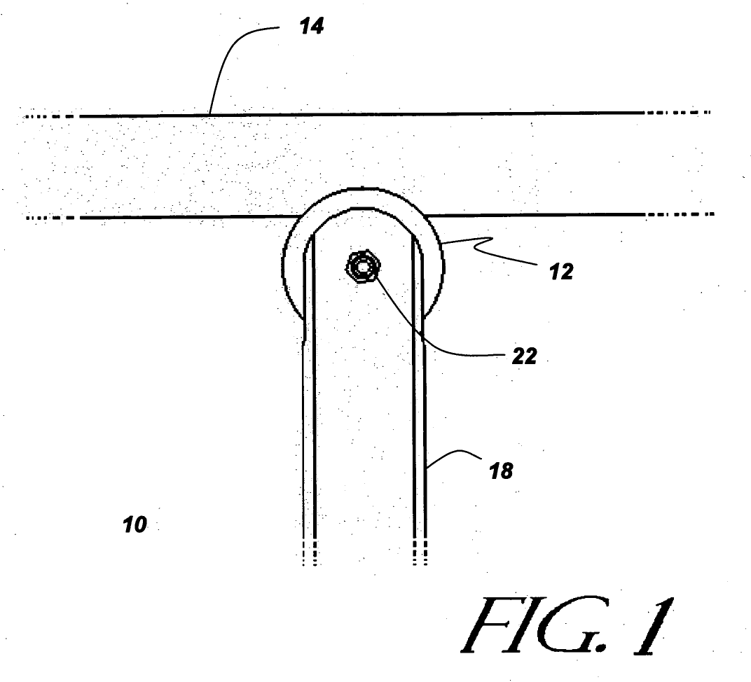

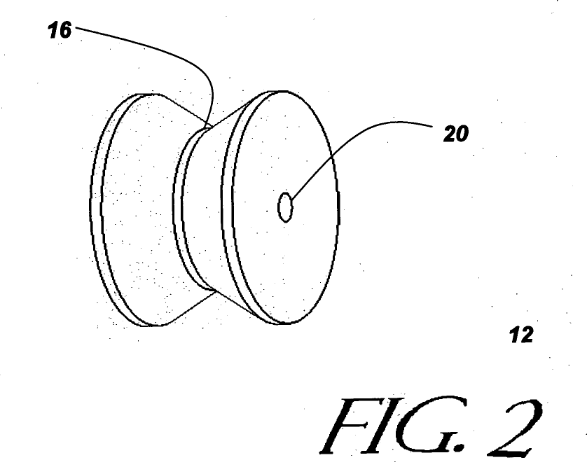

A boom rest 10 is shown in FIG. 1. Unlike prior boom rests, the boom rest 10 has a cylindrical roller 12 for support of a boom 14. The roller 12, best shown in FIG. 2, has cut into it a circumferential V-shaped groove 16. The roller 12, of course, may be molded in which case the groove 16 is not literally cut into the roller 12 but is rather a formed feature of the roller 12. In the preferred embodiment of the roller 12, the groove 16 is sized to correspond to the size and shape of the boom 14 such that the boom 14 will at least partially set within the groove 16. If the boom 14 is round or hexagonal in cross section, the V-shape of the groove 16 maximizes the contact between the roller 12 and the boom 14. Because the space defined by the V-shape of the groove 16 decreases toward the center of the cut, the roller 12 can accommodate varying sizes of booms; smaller booms sit farther into the groove 16.

Referring back to FIG. 1, the roller 16 is preferably mounted on a support structure 18 in a rotatable manner. In the preferred embodiment, the roller 12 has a single generally central bore 20 as best shown in FIG. 2. Again referring back to FIG. 1, a pin 22 is inserted through the bore 22 and attached to the support structure 18 to allow the roller 16 to freely rotate. The pin 22 and the bore 20 thus serve as means for rotatably mounting said roller.

The rotation of the roller 16 allows the boom 14 to self locate onto the roller 14. The V-shape of the groove 12 also allows the boom 14 to self located on the roller on an axis perpendicular to the rotation of the roller. This two way self locating of the boom 14 provided by the preferred embodiment of the boom rest 10 prevents undue wear and damage to the boom 14 and or boom rest 10 during placement of the boom 14. The self locating also ensures that the boom 14 will rest on the roller 12 so as to provide maximum support to the boom 14.

The roller 12 is preferably made of a resilient self lubricating non-metallic material. Such material is preferably sufficiently resilient to withstand the force of the boom 14 as it is lowered onto the roller 12 and further withstand the weight of the boom 14 as it rests on the roller 12 over a long period of time. Because the preferred embodiment of the roller 12 is made of a resilient material, the roller 12 is able to deform under the forces of the boom 14 and return to its normal shape. This modular elasticity of the roller 12 increasing the durability of the roller 12. The rotation of the roller 12 further increases its durability as the roller 12 is able to rotate in response to the motion of the boom 14. The rotation of the roller 12 also limits damage to the boom 14.

The preferred embodiment of the roller 12 is made of a plastic sold under the trademark MC®907 and has a compressive strength of at least about 8000 psi and a modular of elasticity of at least about 400 ksi. MC®907 has an operative temperature range of about −30° F. to about 200° F., and rollers made of this material can therefore be used in nearly any climate. It should be noted, however, that other resilient self-lubricating materials may be used to form the roller 12. The compressive strength and the modular elasticity of the roller 12 may also vary depending upon the anticipated weight of the boom 14 and the force that would be applied to the roller 12 as the boom 14 is dropped down and self-locates onto the roller 12. It is well within the ordinary skill of the art to determine the forces that would be applied to the roller 12 by particular booms and select a sufficiently strong material for the roller 12.

No lubricating agents need be used between the roller 12 and the pin 22 of the preferred embodiment. Self-lubrication is an inherent property of the preferred material of the roller 12. The plastic MC®907 is an example of such a self lubricating material. The self-lubrication of the roller 12 is advantageous in reducing wear to the roller 12 and the pin 22 and further advantageous in reducing the amount of maintenance required to ensure proper operation of the boom rest 10. It is within the ordinary skill of the art, however, to lubricate the roller or to reduce friction by addition of bearings between the roller and the pin 22.

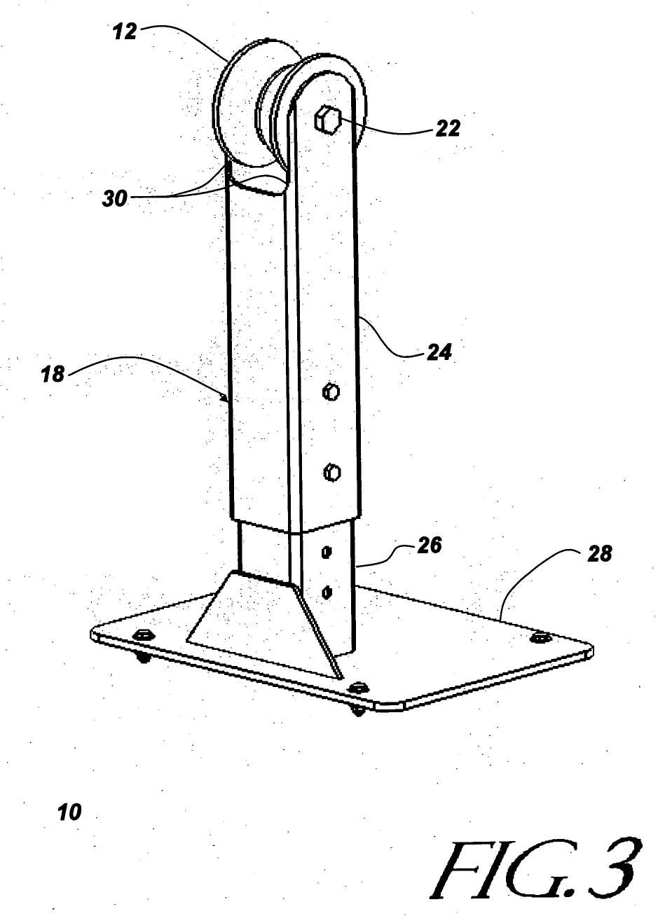

Referring now to FIG. 3, the support structure 18 of the preferred embodiment is formed of an upper portion 24 slidably mounted on a lower portion 26. The lower portion 26 is further attached to a base 28. The slidable relationship of the upper portion 24 to the lower portion 26 allows the height of the support structure 18 to be manipulated in accommodation of the vertical position of the boom 14.

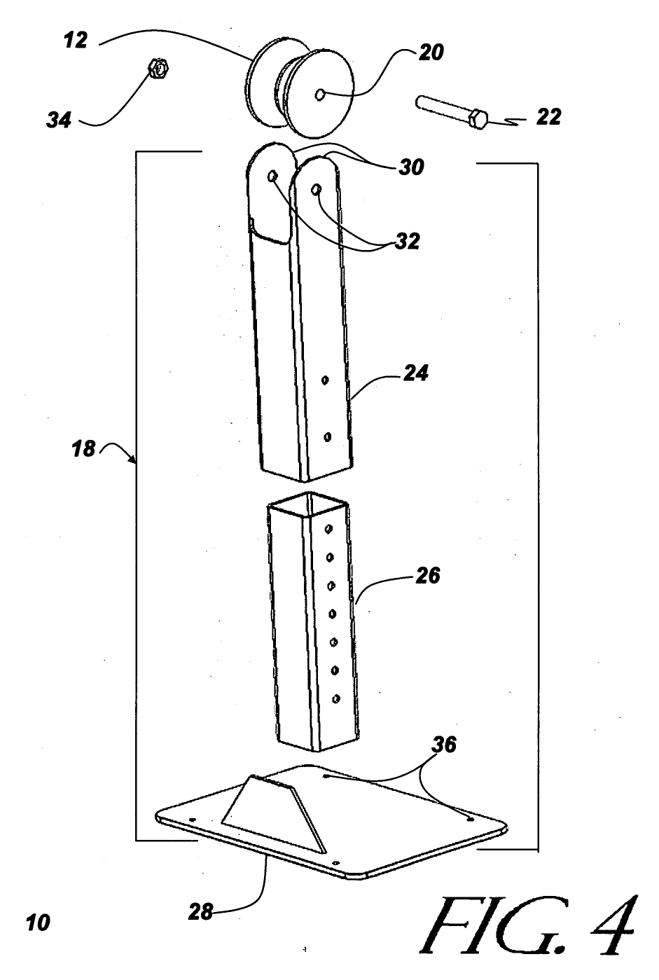

Extending from the upper portion are two opposing flanges 30. The flanges 30 are spaced apart sufficiently for the roller 12 to rotatably fit therebetween. In the preferred embodiment, the flanges 30 each define an aperture 32 for attachment of the pin 22 therethrough. The preferred embodiment of the pin 22 is threaded and attached to the flanges 30 by a nut 34, as indicated in FIG. 4. The pin 22 and the nut 34 therefore serve as means for rotatably mounting the roller 12 to the flanges 30.

The pin 22 may instead be riveted, welded, or adhered to the flanges 30 as alternative means of attachment that are well known in the art. Mounting the roller 12 with the pin 22 and the nut 34 is an advantageous over other known methods of attachment, however, because the roller 12 of the preferred embodiment can be interchanged with a variety of rollers having varying sizes, strengths, and elasticity.

The base 28 of the preferred embodiment includes apertures 36 serving as a securing means. For example, it is useful to secure the base 28 and thus the boom rest 10 to a vehicle or trailer that carries the boom 14. The means of securing the base 28 through the apertures 36 can be any apparatus or means well known in the art, including without limitation screws or bolts. The base 28 does not need apertures 36 for securing the boom rest 10 if the base 28 has sufficient size and weight to secure the boom rest 10 by itself.

Thus, the present invention has been described in an illustrative manner. It is to be understood that the terminology that has been used is intended to be in the nature of words of description rather than of limitation.

Many modifications and variations of the present invention are possible in light of the above teachings. For example, the roller 12 can be of any size and the groove 16 can be of any depth or have any inclusive angle for the V-shape. Therefore, within the scope of the appended claims, the present invention may be practiced otherwise than as specifically described.

What I claim is:

1. A boom rest comprising a cylindrical roller having a circumferential V-shaped groove formed therein for receipt of a boom and a means for rotatably mounting said roller for support of said boom.

2. The boom rest of claim 1 wherein said V-shaped groove is sized to accommodate said boom such that at least a portion of said boom is set therein.

3. The boom rest of claim 2 wherein said roller is composed of a resilient self-lubricating non-metallic material.

4. The boom rest of claim 3 wherein said material is sufficiently strong to support said boom and sufficiently elastic to repeatedly withstand receipt of said boom without substantial damage to said boom rest or said boom.

5. The boom rest of claim 4 wherein said material has a compressive strength of at least about 8000 psi and a modular of elasticity of at least about 400 ksi.

6. The boom rest of claim 1 wherein said means for mounting comprises a single generally central bore through said roller and a pin inserted through said bore for attachment to a support structure.

7. The boom rest of claim 6 wherein said pin is threaded for attachment by a nut.

8. A boom rest comprising.
a cylindrical roller having a circumferential V-shaped groove formed therein for receipt of a boom and a generally central bore therethrough;
a support structure; and
a pin passed through said bore and attached to said support structure for rotatably mounting said roller to said support structure. said roller is made of a resilient self-lubricating non-metallic material.

9. The boom rest of claim 8 wherein said material has a compressive strength of at least about 8000 psi and a modular of elasticity of at least about 400 ksi.

10. A boom rest comprising:
a cylindrical roller having a circumferential V-shaped groove formed therein for receipt of a boom;
a support structure;
two opposing flanges extending upwardly from said support structure and spaced apart sufficiently to receive said roller therebetween; and
means for rotatably mounting said roller to said flanges.

11. The boom rest of claim 10 wherein said means for attachment comprises:
a single generally central bore through said roller;
an aperture defined by each of said flanges;
a pin inserted through said bore and said flanges; and
said pin is attached to said flanges.

12. The boom rest of claim 11 wherein said pin is threaded and said means for attachment includes a nut.

13. The boom rest of claim 11 wherein said pin is riveted to at least one of said flanges.

14. The boom rest of claim 10 wherein said support structure comprises: an upper portion;
a lower portion;
a base;
said upper portion is slidably mounted on said lower portion;
said lower portion is attached to said base; and
said flanges extend upwardly from said upper portion.

15. The boom rest of claim 14 wherein said base defines at least one securing means.

16. The boom rest of claim 15 wherein said securing means is at least one aperture defined by said base.

17. The boom rest of claim 14 wherein said lower portion is welded to said base.

18. The boom rest of claim 10 wherein said roller is composed of a resilient self-lubricating non-metallic material.

19. The boom rest of claim 18 wherein said material is sufficiently strong to support said boom and sufficiently elastic to repeatedly withstand receipt of said boom without substantial damage to said boom rest or said boom.

20. The boom rest of claim 19 wherein said material has a compressive strength of at least about 8000 psi and a modular of elasticity of at least about 400 ksi.
